(19) United States
(12) Patent Application Publication
(10) Pub. No.: US 2026/0237833 A1
(43) Pub. Date: Aug. 13, 2026

(54) ELECTROCHEMICAL APPARATUS AND ELECTRIC DEVICE

(71) Applicant: NINGDE AMPEREX TECHNOLOGY LIMITED, Ningde (CN)

(72) Inventor: Guowen ZHANG, Ningde (CN)

(73) Assignee: NINGDE AMPEREX TECHNOLOGY LIMITED, Ningde (CN)

(21) Appl. No.: 19/635,165

(22) Filed: Mar. 31, 2026

Related U.S. Application Data
(63) Continuation of application No. PCT/CN2024/131037, filed on Nov. 8, 2024.

(30) Foreign Application Priority Data
Nov. 15, 2023 (CN) 202311517153.9

(51) Int. Cl. H01M 50/342

(52) U.S. Cl. CPC H01M 50/3425

(57) ABSTRACT

An electrochemical apparatus including a housing and a pressure relief mechanism. A first wall of the housing is provided with a first through hole. The pressure relief mechanism covers the first through hole, the pressure relief mechanism includes an adhesive film, the adhesive film is capable of melting or losing adhesion when heated to form a first pressure relief channel, a second wall of the housing is provided with a score groove, and the score groove is capable of rupturing when an internal pressure of the housing reaches a threshold to form a second pressure relief channel. A depth S1 of the score groove and a thickness S2 of the second wall meet 0.1*S2≤S1≤0.95*S2.

### CROSS-REFERENCE TO RELATED APPLICATIONS

This application is a continuation application of International Application No. PCT/CN2024/131037, filed on Nov. 8, 2024, which claims the benefit of priority of Chinese patent application 202311517153.9, filed on Nov. 15, 2023, the contents of which are incorporated herein by reference in its entirety.

### TECHNICAL FIELD

The present application relates to the field of battery technologies, and specifically, to an electrochemical apparatus and an electric device.

### BACKGROUND

With the rapid development of new energy technology, batteries have been widely used in fields such as electronic devices, electric automobiles, electric two-wheelers, and electric tools. The requirements for battery quality and safety are increasingly stringent.

Currently, the housing of an electrochemical apparatus is provided with a score groove, which can rupture when the internal pressure of the electrochemical apparatus becomes excessive, so as to form a pressure relief channel to release pressure from the electrochemical apparatus. However, the score groove has poor thermal sensitivity, resulting in low pressure relief reliability and a high probability of thermal runaway.

### SUMMARY

The present application provides an electrochemical apparatus and an electric device, which can effectively improve the pressure relief sensitivity of the electrochemical apparatus.

According to a first aspect, the present application provides an electrochemical apparatus, including:
a housing including a first wall and a second wall, where the first wall is provided with a first through hole; and
a pressure relief mechanism covering the first through hole, where the pressure relief mechanism includes an adhesive film, the adhesive film is capable of melting or losing adhesion when heated to form a first pressure relief channel connecting an interior and an exterior of the housing; where
the second wall is provided with a score groove, the score groove being capable of rupturing when an internal pressure of the housing reaches a threshold to form a second pressure relief channel connecting the interior and the exterior of the housing; and a depth of the score groove is denoted as S1, and a thickness of the second wall is denoted as S2, meeting 0.1*S2≤S1≤0.95*S2.

In the above technical solution, the electrochemical apparatus includes a housing and a pressure relief mechanism, where the housing includes a first wall and a second wall, the pressure relief mechanism covers a first through hole on the first wall, the pressure relief mechanism includes an adhesive film, the adhesive film is capable of melting or losing adhesion when heated to form a first pressure relief channel connecting an interior and an exterior of the housing, the housing further is provided with a score groove, the score groove is capable of rupturing when the internal pressure of the housing reaches a threshold to form a second pressure relief channel connecting the interior and exterior of the housing. That is, when the temperature of the electrochemical apparatus is high, the first pressure relief channel can be formed, and when the internal pressure of the electrochemical apparatus is high, the second pressure relief channel can be formed, thereby enabling the electrochemical apparatus to form two pressure relief channels. When the electrochemical apparatus encounters safety risks, it primarily exhibits two phenomena: heat generation and gas production. The pressure relief mechanism can effectively sense the heat generated in the electrochemical apparatus and relieve pressure upon reaching the melting point. However, in conditions where the electrochemical apparatus produces less heat but more gas, such as over-discharge, the electrochemical apparatus generates less heat but a large amount of gas, thus requiring pressure relief, but the pressure relief mechanism is more sensitive to temperature and may fail to relieve pressure promptly, whereas the score groove can effectively sense gas production in the electrochemical apparatus, and when the gas production reaches a certain level, the housing deforms due to gas expansion, causing the score groove to open. The above solution can adapt to different situations, improving the pressure relief sensitivity and pressure relief reliability of the electrochemical apparatus, and reducing the probability of thermal runaway in the electrochemical apparatus. By ensuring that the depth S1 of the score groove and the thickness S2 of the second wall meet 0.1*S2≤S1≤0.95*S2, the score groove can easily rupture when the internal pressure of the housing is high, providing high pressure relief reliability. Moreover, the score groove has a low cost and is less likely to rupture when the electrochemical apparatus is dropped or subjected to external forces. When the score groove is deeper, the pressure relief response is faster, but if the score groove is too deep, it is prone to rupture, and when the score groove is shallower, it is less likely to rupture, but the pressure relief response is slower. Through the above technical solution, defining the depth of the score groove can balance the relationship between the two. Additionally, since this solution involves the combined action of the pressure relief mechanism and the score groove, the depth of the score groove can be made smaller without causing a slow pressure relief response. In an electrochemical apparatus with only a single score groove for pressure relief, due to the low pressure relief sensitivity of the score groove, the score groove needs to be deepened, but a deeper score groove may cause issues such as electrolyte leakage during rolling or dropping, and the cost of the score groove is high. Through a multi-channel pressure relief structure in this solution, the depth of the score groove can be limited within the above range.

In some embodiments of the first aspect, 0.4*S2≤S1≤0.8*S2.

In the above technical solution, by ensuring that the depth S1 of the score groove and the thickness S2 of the second wall meet 0.4*S2≤S1≤0.8*S2, the score groove can more easily rupture when the internal pressure of the housing is high, providing higher pressure relief reliability, and the score groove has a lower cost and is less likely to rupture when the electrochemical apparatus is dropped or subjected to external forces.

In some embodiments of the first aspect, 0.55*S2≤S1≤0.8*S2.

In the above technical solution, by ensuring that the depth S1 of the score groove and the thickness S2 of the second wall meet 0.55*S2≤S1≤0.8*S2, the score groove can more easily rupture when the internal pressure of the housing is high, providing higher pressure relief reliability, and the score groove has a lower cost and is less likely to rupture when the electrochemical apparatus is dropped or subjected to external forces. By integrating the thermal melting pressure relief (pressure relief mechanism) and the score groove into the housing of the same electrochemical apparatus, the depth S1 of the score groove and the thickness S2 of the second wall can meet 0.55*S2≤S1≤0.8*S2.

In some embodiments of the first aspect, the pressure relief mechanism further includes a first metal sheet, where the first metal sheet is disposed on a side of the adhesive film facing away from the housing.

In the above technical solution, by disposing the first metal sheet on the side of the adhesive film facing away from the housing, the water seepage area of the adhesive film can be reduced, improving the sealing effect of the pressure relief mechanism.

In some embodiments of the first aspect, the first metal sheet is configured in a circular shape, the adhesive film is configured in circular or annular shape, the first through hole is configured in a circular shape, a diameter of the first metal sheet is less than or equal to an outer diameter of the adhesive film, and the diameter of the first metal sheet is greater than or equal to a diameter of the first through hole.

In the above technical solution, by configuring the first metal sheet to be circular, the adhesive film to be circular or annular, and the first through hole to be circular, and ensuring that the diameter of the first metal sheet is less than or equal to the outer diameter of the adhesive film and the diameter of the first metal sheet is greater than or equal to the diameter of the first through hole, it facilitates the assembly of the adhesive film, the first metal sheet, and the housing. Additionally, the first metal sheet can cover the first through hole, reducing the likelihood of water vapor infiltrating the interior of the housing through the adhesive film and the first through hole, thereby improving the sealing effect of the pressure relief mechanism.

In some embodiments of the first aspect, the pressure relief mechanism further includes a second metal sheet, where the second metal sheet is disposed between the adhesive film and the housing, the second metal sheet is welded to the housing, and the second metal sheet is provided with a second through hole.

In the above technical solution, by providing the second metal sheet to be welded to the housing, the connection between the pressure relief mechanism and the housing can be more stable, and the sealing effect can be better.

In some embodiments of the first aspect, the first metal sheet is circular, the first through hole is configured in a circular shape, the second metal sheet is configured in an annular shape, an outer diameter of the second metal sheet is greater than or equal to the diameter of the first through hole, the diameter of the first metal sheet is less than or equal to the outer diameter of the second metal sheet, and the diameter of the first metal sheet is greater than or equal to an inner diameter of the second metal sheet.

In the above technical solution, by configuring the first metal sheet to be circular, the first through hole to be circular, and the second metal sheet to be annular, and ensuring that the outer diameter of the second metal sheet is greater than or equal to the diameter of the first through hole, it facilitates the welding of the second metal sheet to the housing. The diameter of the first metal sheet being less than or equal to the outer diameter of the second metal sheet can reduce the likelihood of the first metal sheet obstructing the welding of the second metal sheet to the housing; and the diameter of the first metal sheet being greater than or equal to the inner diameter of the second metal sheet enables the first metal sheet to cover the second through hole, reducing the likelihood of water vapor infiltrating the interior of the housing through the adhesive film and the second through hole, thereby improving the sealing effect of the pressure relief mechanism.

In some embodiments of the first aspect, the first through hole is configured in a circular shape, a diameter of the first through hole is denoted as D1, the second metal sheet is configured in an annular shape, an outer diameter of the second metal sheet is denoted as D2, and an inner diameter of the second metal sheet is denoted as D3, meeting 0.2 mm≤D1≤5 mm, 1 mm≤D2≤6 mm, and 0.1 mm≤D3≤3 mm.

In the above technical solution, by setting the diameter D1 of the first through hole to be between 0.2 mm and 5 mm, the first through hole can provide a first pressure relief channel with a large cross-sectional area during thermal runaway of the electrochemical apparatus. Moreover, this avoids the need for a large-sized pressure relief mechanism to cover the first through hole, facilitating the installation of the pressure relief mechanism. By setting the outer diameter D2 of the second metal sheet to be between 1 mm and 6 mm, the second metal sheet has sufficient area to adhere to the housing, which can facilitate the welding of the second metal sheet to the housing, and the second metal sheet does not extend beyond the housing, resulting in lower costs. By setting the inner diameter D3 of the second metal sheet to be between 0.1 mm and 3 mm, the second through hole can provide a first pressure relief channel with a large cross-sectional area when the first pressure relief channel is formed through the second through hole. Moreover, this avoids the need for a large-sized adhesive film and first metal sheet to cover the second through hole, facilitating the installation of the adhesive film and the first metal sheet.

In some embodiments of the first aspect, a thickness of the first metal sheet is denoted as H1, and a thickness of the second metal sheet is denoted as H2, meeting 0.03 mm≤H1≤1 mm and 0.03 mm≤H2≤1 mm.

In the above technical solution, by setting the thickness H1 of the first metal sheet to be between 0.03 mm and 1 mm and the thickness H2 of the second metal sheet to be between 0.03 mm and 1 mm, the first metal sheet and the second metal sheet achieve a better sealing effect, reducing the likelihood of water vapor infiltrating the interior of the housing. Additionally, this can keep the thickness of the pressure relief mechanism relatively small, thereby minimizing the space occupied by the pressure relief mechanism in the length direction of the electrochemical apparatus, and facilitating an increase in the energy density of the electrochemical apparatus.

In some embodiments of the first aspect, a melting point of the adhesive film is denoted as T, meeting 95° C. ≤T≤135° C.

In the above technical solution, by setting the melting point T of the adhesive film to be between 95° C. and 135° C., the adhesive film can achieve high sealing reliability for the first through hole, and during thermal runaway of the electrochemical apparatus, the adhesive film can melt or lose adhesion to form the first pressure relief channel, resulting in high pressure relief sensitivity of the electrochemical apparatus.

In some embodiments of the first aspect, the adhesive film includes a first adhesive layer and a second adhesive layer, where the first adhesive layer and the second adhesive layer are stacked, the second adhesive layer is located on a side of the first adhesive layer facing away from the housing, and a melting point of the first adhesive layer being lower than a melting point of the second adhesive layer.

In the above technical solution, by providing the first adhesive layer and the second adhesive layer, and ensuring that the melting point of the first adhesive layer is less than that of the second adhesive layer, when the adhesive film is activated by high temperature, the first adhesive layer can melt to adhere to the housing, while the second adhesive layer does not melt, which can prevent excessive melting of the adhesive film that could affect the installation of the adhesive film and can also reduce the amount of adhesive overflow of the adhesive film.

In some embodiments of the first aspect, a melting point of the first adhesive layer is denoted as T1, and a melting point of the second adhesive layer is denoted as T2, meeting 95° C. ≤T1≤135° C. and 140° C. ≤T2≤190° C.

In the above technical solution, by setting the melting point T1 of the first adhesive layer to be between 95° C. and 135° C. and the melting point T2 of the second adhesive layer to be between 140° C. and 190° C., the adhesive film can achieve high sealing reliability for the first through hole, and the first adhesive layer can melt before the second adhesive layer, facilitating installation on the housing when the adhesive film is activated by high temperature; and during thermal runaway of the electrochemical apparatus, the first adhesive layer can melt or lose adhesion before the second adhesive layer to form the first pressure relief channel, resulting in high pressure relief sensitivity of the electrochemical apparatus and reducing the amount of adhesive overflow of the adhesive film.

In some embodiments of the first aspect, the pressure relief mechanism further includes a first metal sheet, where the first metal sheet is disposed on a side of the adhesive film facing away from the housing; and the adhesive film further includes a third adhesive layer, where the third adhesive layer is located between the second adhesive layer and the first metal sheet, and a melting point of the third adhesive layer is lower than the melting point of the second adhesive layer.

In the above technical solution, by providing the third adhesive layer and ensuring that the melting point of the third adhesive layer is less than that of the second adhesive layer, when the adhesive film is activated by high temperature, the third adhesive layer can melt to adhere to the first metal sheet, while the second adhesive layer does not melt, which can prevent excessive melting of the adhesive film that could affect the installation of the first metal sheet and can also reduce the amount of adhesive overflow. During thermal runaway of the electrochemical apparatus, both the first adhesive layer and the third adhesive layer can melt or lose adhesion to form the first pressure relief channel, improving the pressure relief sensitivity and pressure relief reliability of the electrochemical apparatus and reducing the probability of thermal runaway of the electrochemical apparatus.

In some embodiments of the first aspect, a melting point of the third adhesive layer is denoted as T3, meeting 95° C. ≤T3≤135° C.

In the above technical solution, by setting the melting point T3 of the third adhesive layer to be between 95° C. and 135° C., the adhesive film can achieve high the sealing reliability for the first through hole, and the third adhesive layer can melt or lose adhesion before the second adhesive layer, facilitating installation on the first metal sheet when the adhesive film is activated by high temperature. During thermal runaway of the electrochemical apparatus, the third adhesive layer can melt or lose adhesion before the second adhesive layer to form the first pressure relief channel, resulting in high pressure relief sensitivity of the electrochemical apparatus.

In some embodiments of the first aspect, the housing is provided with a groove, the first through hole extends through the groove, and the pressure relief mechanism is accommodated in the groove.

In the above technical solution, by providing a groove in the housing, with the first through hole extending through the groove and the pressure relief mechanism accommodated in the groove, the portion of the pressure relief mechanism protruding beyond the outer surface of the housing has a small thickness, or the pressure relief mechanism does not protrude beyond the outer surface of the housing, thereby reducing the likelihood of the pressure relief mechanism being damaged or detached from the housing due to interference with other components.

In some embodiments of the first aspect, the first through hole is configured in a racetrack shape, rectangular shape, or elliptical shape.

In the above technical solution, by configuring the first through hole in a racetrack shape, rectangular shape, or elliptical shape, when the thickness of the electrochemical apparatus is small, an area of the first through hole is large, providing high pressure relief reliability.

In some embodiments of the first aspect, the housing includes a shell and a shell cover, where the shell includes a bottom wall and a plurality of side walls surrounding the bottom wall, the bottom wall and the plurality of side walls together form an accommodation space with an opening, the shell cover seals the opening, the side wall is the first wall, and the bottom wall or the shell cover is the second wall.

In the above technical solution, by disposing the first through hole on the side wall of the shell, the likelihood of the first pressure relief channel being obstructed can be reduced, and the pressure relief reliability of the pressure relief mechanism is high. By disposing the score groove on the bottom wall or the shell cover of the shell, a larger second pressure relief channel can be formed, facilitating rapid discharge of gas inside the housing, and providing high pressure relief reliability.

In some embodiments of the first aspect, the electrochemical apparatus further includes a terminal post, where the terminal post and the first through hole are disposed on the same side wall.

In the above technical solution, on the side of the electrochemical apparatus where the terminal post is disposed, a clearance space is formed between the electrode assembly and the housing. By disposing the terminal post and the first through hole on the same side wall, gas inside the housing can be discharged through the clearance space and the first through hole, providing high pressure relief reliability. Furthermore, since space needs to be reserved for the terminal post to electrically connect with other devices of the electric device when the electrochemical apparatus is installed in the electric device, disposing the terminal post and the first through hole on the same side wall eliminates the need to reserve additional space for the pressure relief mechanism to achieve pressure relief, saving space in the electric device and making the structure of the electric device more compact.

In some embodiments of the first aspect, the electrochemical apparatus further includes a terminal post, where the terminal post and the first through hole are disposed on different side walls.

In the above technical solution, since the terminal post can be used to connect to a circuit board, by disposing the terminal post and the first through hole on different side walls, after the pressure relief mechanism forms the first pressure relief channel, the electrolyte inside the electrochemical apparatus can be less likely to spray onto the circuit board through the first pressure relief channel, reducing the likelihood of the electrolyte causing a short circuit in the components on the circuit board.

In some embodiments of the first aspect, the score groove is disposed in a corner of the housing.

In the above technical solution, since the corner of the housing is a stress concentration region, by disposing the score groove in the corner of the housing, the score groove can be more likely to rupture when the internal pressure of the housing is high, providing higher pressure relief reliability.

In some embodiments of the first aspect, the electrochemical apparatus further includes a terminal post, where the terminal post is disposed on the housing, and the score groove is disposed towards an end of the housing where the terminal post is located.

In the above technical solution, on the side of the electrochemical apparatus where the terminal post is disposed, a clearance space is formed between the electrode assembly and the housing. By disposing the score groove towards the end of the housing where the terminal post is located, gas inside the housing can be discharged through the clearance space and a pressure relief opening formed by the rupture of the score groove, providing high pressure relief reliability.

In some embodiments of the first aspect, the score groove is configured in an arc shape and bends toward the center of the shell cover or the bottom wall where the score groove is located.

In the above technical solution, by configuring the score groove in an arc shape and bending toward the center of the shell cover or the bottom wall where the score groove is located, the processing and formation of the score groove are facilitated. Additionally, when the internal pressure of the housing is high, the central portion of the shell cover or bottom wall is subjected to greater force, thus the score groove is more likely to rupture and form a larger pressure relief opening, facilitating rapid discharge of gas inside the housing, and providing high pressure relief reliability.

In some embodiments of the first aspect, a width of the score groove gradually decreases in a direction toward the interior of the housing.

In the above technical solution, by configuring the width of the score groove to gradually decrease in the direction toward the interior of the housing, the processing cost of the score groove can be reduced, and the likelihood of thermal deformation of the shell cover or bottom wall where the score groove is located can be reduced.

In some embodiments of the first aspect, a maximum width of the score groove is denoted as W, meeting 0.02 mm≤W≤0.5 mm.

In the above technical solution, by setting the maximum width W of the score groove to be between 0.02 mm and 0.5 mm, the score groove can easily rupture when the internal pressure of the housing is high, providing high pressure relief reliability, and the score groove has a low cost and is less likely to rupture when the electrochemical apparatus is dropped or subjected to external forces.

In some embodiments of the first aspect, 0.05 mm≤W≤0.2 mm.

In the above technical solution, by setting the maximum width W of the score groove to be between 0.05 mm and 0.2 mm, the score groove can more easily rupture when the internal pressure of the housing is high, providing higher pressure relief reliability, and the score groove has a lower cost and is less likely to rupture when the electrochemical apparatus is dropped or subjected to external forces.

In some embodiments of the first aspect, 0.06 mm≤W≤0.18 mm.

In the above technical solution, by setting the maximum width W of the score groove to be between 0.06 mm and 0.18 mm, the score groove can more easily rupture when the internal pressure of the housing is high, providing higher pressure relief reliability, and the score groove has a lower cost and is less likely to rupture when the electrochemical apparatus is dropped or subjected to external forces. By integrating the thermal melting pressure relief (pressure relief mechanism) and the score groove into the housing of the same electrochemical apparatus, the maximum width W of the score groove can be set to be between 0.06 mm and 0.18 mm.

In some embodiments of the first aspect, a thickness S2 of the second wall meets 0.03 mm≤S2≤0.3 mm.

In the above technical solution, by setting the thickness S2 of the second wall to be between 0.03 mm and 0.3 mm, the second wall can be less likely to deform under force or heat, and the space occupied by the second wall is small, which contributes to increasing the energy density of the electrochemical apparatus.

According to a second aspect, the present application provides an electric device including the electrochemical apparatus as described above, where the electrochemical apparatus is configured to provide electrical energy.

### BRIEF DESCRIPTION OF DRAWINGS

To more clearly illustrate the technical solutions of some embodiments of the present application, the accompanying drawings required for use in these embodiments will be briefly introduced below. It should be understood that the following drawings only show certain embodiments of the present application and should not be considered as limiting the scope. For those of ordinary skill in the art, other related drawings can be obtained based on these drawings.

FIG. 1 is a schematic perspective view of a structure of an electrochemical apparatus according to some embodiments of the present application;

FIG. 2 is a schematic exploded view of a structure of an electrochemical apparatus according to some embodiments of the present application;

FIG. 3 is a schematic cross-sectional view of a structure of an electrochemical apparatus according to some embodiments of the present application;

FIG. 4 is a schematic partial enlarged view of a structure at A of the electrochemical apparatus shown in FIG. 3;

FIG. 5 is a schematic diagram of a structure of a portion of an electrochemical apparatus from one perspective according to some embodiments of the present application;

FIG. 6 is a schematic perspective view of a structure of an electrochemical apparatus according to other embodiments of the present application;

FIG. 7 is a schematic cross-sectional view of a structure of a portion of the electrochemical apparatus according to the embodiment of FIG. 6;

FIG. 8 is a schematic perspective view of a structure of an electrochemical apparatus according to other embodiments of the present application;

FIG. 9 is a schematic cross-sectional view of a structure of a portion of the electrochemical apparatus according to the embodiment of FIG. 8;

FIG. 10 is a schematic diagram of a structure of an adhesive film of an electrochemical apparatus from one perspective according to some embodiments of the present application;

FIG. 11 is a schematic cross-sectional view of a structure of an adhesive film of an electrochemical apparatus from another perspective according to some embodiments of the present application;

FIG. 12 is a schematic diagram of a structure of an electrochemical apparatus from one perspective according to some embodiments of the present application;

FIG. 13 is a schematic cross-sectional view of a structure of an electrochemical apparatus from another perspective according to some embodiments of the present application; and

FIG. 14 is a schematic partial enlarged view of a structure at B of the electrochemical apparatus shown in FIG. 13.

Reference signs: 10. electrochemical apparatus; 100. housing; 101. first through hole; 102. score groove; 110. shell; 111. bottom wall; 112. first side wall; 113. second side wall; 114. third side wall; 115. fourth side wall; 120. shell cover; 200.

pressure relief mechanism; 210. adhesive film; 211. first adhesive layer; 212. second adhesive layer; 213. third adhesive layer; 220. first metal sheet; 230. second metal sheet; 231. second through hole; 300. terminal post; and 400. electrode assembly.

### DESCRIPTION OF EMBODIMENTS

To make the objectives, technical solutions, and advantages of the present application clearer, the technical solutions in some embodiments of the present application will be clearly described below with reference to the accompanying drawings in these embodiments of the present application. Obviously, the described embodiments are a part of these embodiments of the present application, not all embodiments. Based on these embodiments in the present application, all other embodiments obtained by those of ordinary skill in the art fall within the scope of protection of the present application.

Unless otherwise defined, all technical and scientific terms used in the present application have the same meaning as commonly understood by those skilled in the technical field of the present application; the terms used in the specification of the present application are for the purpose of describing specific embodiments only and are not intended to limit the present application; the terms “including” and “having” in the specification, claims, and accompanying drawings of the present application, as well as any variations thereof, are intended to cover non-exclusive inclusion.

The terms “first,” “second,” and the like in the specification, claims, or accompanying drawings of the present application are used to distinguish different objects, not to describe a specific order or priority.

Reference to an “embodiment” in the present application means that a specific feature, structure, or characteristic described in connection with this embodiment may be included in at least one embodiment of the present application. The appearance of this phrase in various places in the specification does not necessarily refer to the same embodiment, nor is it an independent or alternative embodiment mutually exclusive with other embodiments.

In some embodiments of the present application, the same reference signs denote the same components, and for brevity, detailed descriptions of the same components are omitted in different embodiments. It should be understood that the thickness, length, width, and other dimensions of various components in these embodiments of the present application shown in the accompanying drawings, as well as the overall thickness, length, width, and other dimensions of an integrated device, are for illustrative purposes only and should not constitute any limitation to the present application.

In the present application, the electrochemical apparatus may be a secondary battery or a primary battery; for example, the electrochemical apparatus may be a lithium-ion battery, a sodium-ion battery, or a magnesium-ion battery, which is not limited by some embodiments of the present application. The electrochemical apparatus may be in the shape of a cylinder, a flat body, a cuboid, or other shapes, which is not limited by some embodiments of the present application. The electrode assembly may be a wound structure or a laminated structure, which is not limited by some embodiments of the present application.

With the development of the new energy industry, the requirements for battery quality and safety are increasingly stringent. Electrochemical apparatuses have outstanding advantages such as high energy density, low environmental pollution, high power density, long service life, wide adaptability, and low self-discharge coefficient, making them an important part of the development of new energy today.

In current electrochemical apparatuses, laser scoring is mainly used on the shell cover to form a score groove, and the score groove can rupture when the internal gas pressure of the electrochemical apparatus becomes excessive, forming a pressure relief channel to discharge gas from the cell interior, serving an explosion-proof function. However, the score groove primarily relies on the internal gas pressure of the electrochemical apparatus to rupture, with poor thermal sensitivity and a low pass rate in hot chamber test; when the temperature of the electrochemical apparatus is high but the gas pressure has not reached the preset value, the probability of the score groove rupturing is low, and there remains a risk of thermal runaway in the electrochemical apparatus.

Based on the above considerations, to address the issue of low pressure relief sensitivity in current electrochemical apparatuses, the present application provides an electrochemical apparatus. The electrochemical apparatus includes a housing and a pressure relief mechanism, where the housing includes a first wall and a second wall, the first wall is provided with a first through hole, the pressure relief mechanism covers the first through hole, the pressure relief mechanism includes an adhesive film, the adhesive film is capable of melting or losing adhesion when heated to form a first pressure relief channel connecting an interior and an exterior of the housing, the second wall is provided with a score groove, the score groove is capable of rupturing when the internal pressure of the housing reaches a threshold to form a second pressure relief channel connecting the interior and the exterior of the housing; and a depth of the score groove is denoted as S1, and a thickness of the second wall is denoted as S2, meeting 0.1*S2≤S1≤0.95*S2. When the temperature of the electrochemical apparatus is high, the first pressure relief channel can be formed, and when the internal pressure of the electrochemical apparatus is high, the second pressure relief channel can be formed, thereby enabling the electrochemical apparatus to form two pressure relief channels to adapt to different situations, improving the pressure relief sensitivity and pressure relief reliability of the electrochemical apparatus, and reducing the probability of thermal runaway of the electrochemical apparatus. Furthermore, by ensuring that 0.1*S2≤S1 ≤0.95*S2, the score groove can easily rupture when the internal pressure of the housing is high, providing high pressure relief reliability. Moreover, the score groove has a low cost and is less likely to rupture when the electrochemical apparatus is dropped or subjected to external forces; when the score groove is deeper, the pressure relief response is faster, but if the score groove is too deep, it is prone to rupture, and when the score groove is shallower, it is less likely to rupture, but the pressure relief response is slower. Through the above technical solution, defining the depth of the score groove can balance the relationship between the two, and since this solution involves the combined action of the pressure relief mechanism and the score groove, the depth of the score groove can be made smaller without causing a slow pressure relief response.

An embodiment of the present application provides an electric device using the electrochemical apparatus as a power source. The electric device includes, but not limited to, a mobile phone, a tablet, a laptop, an electric toy, an electric tool, an electric bicycle, an electric automobile, a ship, a spacecraft, and the like. The electric toy may include a fixed or mobile electric toy, such as a game console, an electric car toy, an electric ship toy, and an electric airplane toy, and the spacecraft may include an airplane, a rocket, a space shuttle, and a spaceship.

The electrochemical apparatus described in some embodiments of the present application is not limited to the electric device described above but can be applied to all electric device using electrochemical apparatuses.

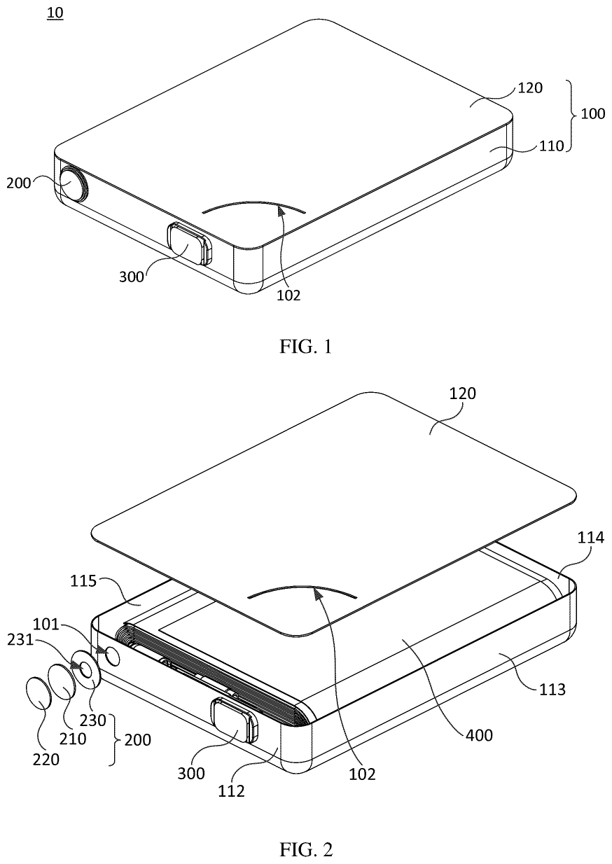

Referring to FIG. 1 and FIG. 2, FIG. 1 is a schematic perspective view of a structure of an electrochemical apparatus according to some embodiments of the present application, and FIG. 2 is a schematic exploded view of a structure of an electrochemical apparatus according to some embodiments of the present application. The electrochemical apparatus 10 includes a housing 100, a terminal post 300, and an electrode assembly 400, where the housing 100 forms an accommodation space for accommodating the electrode assembly 400 and an electrolyte, and the terminal post 300 extends through the housing 100 and is electrically connected to the electrode assembly 400. The electrode assembly 400 includes a positive electrode sheet, a negative electrode sheet, and a separator, where the positive electrode sheet includes a positive electrode current collector and a positive electrode active material layer, the positive electrode active material layer is applied on a surface of the positive electrode current collector. Taking a lithium-ion battery as an example, a material of the positive electrode current collector may be aluminum, and a positive electrode active material may be lithium cobalt oxide, lithium iron phosphate, ternary lithium, or lithium manganate. The negative electrode sheet includes a negative electrode current collector and a negative electrode active material layer, where the negative electrode active material layer is applied on a surface of the negative electrode current collector. A material of the negative electrode current collector may be copper, and a negative electrode active material may be carbon or silicon. The electrochemical apparatus 10 operates primarily by the movement of metal ions between the positive electrode sheet and the negative electrode sheet. During the operation of the electrochemical apparatus 10, the temperature of the electrochemical apparatus 10 rises, and the electrode assembly 400 may generate gas, increasing the internal pressure of the housing 100. The continuous accumulation of internal pressure in the housing 100 may cause an explosion, and an excessively high temperature of the electrochemical apparatus 10 may lead to thermal runaway, potentially causing damage to the electrochemical apparatus 10.

In some embodiments of the present application, the electrochemical apparatus 10 includes a housing 100 and a pressure relief mechanism 200, where the housing 100 includes a first wall and a second wall, the first wall is provided with a first through hole 101. The pressure relief mechanism 200 covers the first through hole 101, and the pressure relief mechanism 200 includes an adhesive film 210, the adhesive film 210 being capable of melting or losing adhesion when heated to form a first pressure relief channel connecting the interior and the exterior of the housing 100. The second wall is provided with a score groove 102, the score groove 102 being capable of rupturing when the internal pressure of the housing 100 reaches a threshold to form a second pressure relief channel connecting the interior and exterior of the housing 100. A depth of the score groove 102 is denoted as S1, and a thickness of the second wall is denoted as S2, meeting 0.1*S2≤S1≤0.95*S2. For example, S1 may be 0.1*S2, 0.5*S2, or 0.95*S2.

In some embodiments, the score groove 102 may be formed by laser etching.

By providing the pressure relief mechanism 200, the pressure relief mechanism 200 covers the first through hole 101 of the first wall, the pressure relief mechanism 200 includes an adhesive film 210, the adhesive film 210 is capable of melting or losing adhesion when heated to form a first pressure relief channel connecting the interior and exterior of the housing 100, the second wall is provided with a score groove 102, the score groove 102 is capable of rupturing when the internal pressure of the housing 100 reaches a threshold to form a second pressure relief channel connecting the interior and exterior of the housing 100. That is, when the temperature of the electrochemical apparatus 10 is high, the first pressure relief channel can be formed, and when the internal pressure of the electrochemical apparatus 10 is high, the second pressure relief channel can be formed, thereby enabling the electrochemical apparatus 10 to form two pressure relief channels. When the electrochemical apparatus 10 encounters safety risks, it primarily exhibits two phenomena: heat generation and gas production. The pressure relief mechanism 200 can effectively sense the heat generated in the electrochemical apparatus 10 and relieve pressure upon reaching the melting point. However, in conditions where the electrochemical apparatus 10 produces less heat but more gas, such as over-discharge, the electrochemical apparatus 10 generates less heat but a large amount of gas, thus requiring pressure relief, but the pressure relief mechanism 200 is more sensitive to temperature and may fail to relieve pressure promptly, whereas the score groove 102 can effectively sense gas production in the electrochemical apparatus 10, and when the gas production reaches a certain level, the housing deforms due to gas expansion, causing the score groove 102 to open. The above solution can adapt to different situations, improving the pressure relief sensitivity and pressure relief reliability of the electrochemical apparatus 10 and reducing the probability of thermal runaway in the electrochemical apparatus 10. By ensuring that the depth S1 of the score groove 102 and the thickness S2 of the second wall meet 0.1*S2≤S1≤0.95*S2, the score groove 102 can easily rupture when the internal pressure of the housing 100 is high, providing high pressure relief reliability. Moreover, the score groove 102 has a low cost and is less likely to rupture when the electrochemical apparatus 10 is dropped or subjected to external forces. When the score groove 102 is deeper, the pressure relief response is faster, but if the score groove 102 too deep, it is prone to rupture, and when the score groove 102 is shallower, it is less likely to rupture, but the pressure relief response is slower. Through the above technical solution, defining the depth of the score groove 102 can balance the relationship between the two. Additionally, since this solution involves the combined action of the pressure relief mechanism 200 and the score groove 102, the depth of the score groove 102 can be made smaller without causing a slow pressure relief response. In an electrochemical apparatus 10 with only a single score groove 102 for pressure relief, due to the low pressure relief sensitivity of the score groove 102, the score groove 102 needs to be deepened, but a deeper score groove 102 may cause issues such as electrolyte leakage during rolling or dropping, and the cost of the score groove 102 is high. Through a multi-channel pressure relief structure in this solution, the depth of the score groove 102 can be limited within the above range.

When the internal pressure of the housing 100 is high, the pressure relief mechanism 200 can also form the first pressure relief channel under pressure, thereby accelerating gas discharge.

In some embodiments, the first through hole 101 may be an electrolyte injection hole, and an electrolyte is injected into the interior of the electrochemical apparatus 10 through the first through hole 101.

By reusing the electrolyte injection hole as the first through hole 101 for pressure relief, the preparation process of the electrochemical apparatus 10 can be further simplified, the number of hole-punching steps can be reduced, and the preparation cost of the electrochemical apparatus 10 can be lowered.

In some other embodiments, the first through hole 101 may alternatively be another through hole formed in the housing 100.

In some embodiments, 0.4*S2≤S1≤0.8*S2. For example, S1 may be 0.4*S2, 0.6*S2, or 0.8*S2.

By ensuring that the depth S1 of the score groove 102 and the thickness S2 of the second wall meet 0.4*S2≤S1≤0.8*S2, the score groove 102 can more easily rupture when the internal pressure of the housing 100 is high, providing higher pressure relief reliability, and the score groove 102 has a lower cost and is less likely to rupture when the electrochemical apparatus 10 is dropped or subjected to external forces.

In some embodiments, 0.55*S2≤S1≤0.8*S2. For example, S1 may be 0.55*S2, 0.65*S2, or 0.8*S2.

By ensuring that the depth S1 of the score groove 102 and the thickness S2 of the second wall meet 0.55*S2≤S1≤0.8*S2, the score groove 102 can more easily rupture when the internal pressure of the housing 100 is high, providing higher pressure relief reliability, and the score groove 102 has a lower cost and is less likely to rupture when the electrochemical apparatus 10 is dropped or subjected to external forces. By integrating the thermal melting pressure relief (pressure relief mechanism 200) and the score groove 102 into the housing of the same electrochemical apparatus 10, the depth S1 of the score groove 102 and the thickness S2 of the second wall can meet 0.55*S2 ≤S1≤0.8*S2.

In some embodiments, the pressure relief mechanism 200 may further include a first metal sheet 220, where the first metal sheet 220 is disposed on a side of the adhesive film 210 facing away from the housing 100.

In some embodiments, the first metal sheet 220 and the adhesive film 210 are stacked along the thickness direction of the adhesive film 210. Since the adhesive film 210 is made of a polymer with water permeability, and water entering the interior of the housing 100 through the adhesive film 210 can adversely affect the electrode assembly 400 and the electrolyte, by disposing the first metal sheet 220 on the side of the adhesive film 210 facing away from the housing 100, the first metal sheet 220 can cover at least a portion of the adhesive film 210, the water seepage area of the adhesive film 210 can be reduced, improving the sealing effect, thereby extending the service life of the electrochemical apparatus 10.

In some embodiments, the adhesive film 210 may be made of a polymer, such as polypropylene (PP, polypropylene), which has good toughness and chemical resistance.

In some embodiments, the first metal sheet 220 may be made of materials such as aluminum, nickel, or stainless steel, which are resistant to rust and have a long service life.

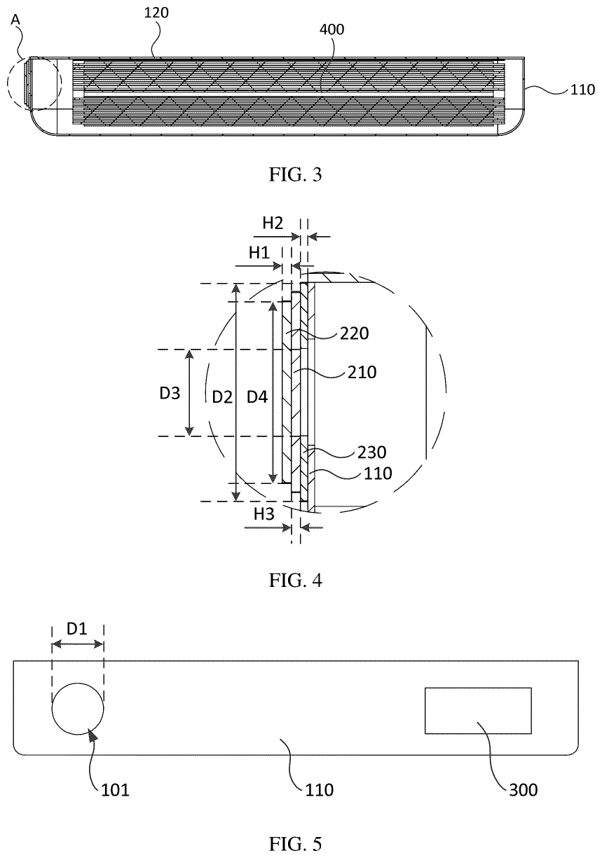

Referring to FIG. 3 to FIG. 5, FIG. 3 is a schematic cross-sectional view of a structure of an electrochemical apparatus according to some embodiments of the present application, FIG. 4 is a schematic partial enlarged view of a structure at A of the electrochemical apparatus shown in FIG. 3, and FIG. 5 is a schematic diagram of a structure of a portion of an electrochemical apparatus from one perspective according to some embodiments of the present application.

In some embodiments, the first metal sheet 220 is configured in a circular shape, the adhesive film 210 is configured in a circular shape, the first through hole 101 is configured in a circular shape, a diameter D4 of the first metal sheet 220 is less than or equal to an outer diameter D2 of the adhesive film 210, and the diameter D4 of the first metal sheet 220 is greater than or equal to a diameter D1 of the first through hole 101.

By configuring the first metal sheet 220 to be circular, there is no need to adjust the assembly direction of the first metal sheet 220, facilitating the assembly between the first metal sheet 220 and the adhesive film 210. By configuring the adhesive film 210 to be circular and the first through hole 101 to be circular, there is no need to adjust the assembly direction of the adhesive film 210, facilitating the assembly between the adhesive film 210 and the housing 100. Additionally, when the axis of the adhesive film 210 is aligned with the axis of the first through hole 101, the contact surface between the adhesive film 210 and the housing 100 is uniformly distributed, improving the sealing effect. By ensuring that the diameter D4 of the first metal sheet 220 is less than or equal to the outer diameter D2 of the adhesive film 210, the likelihood of the first metal sheet 220 obstructing the adhesive film 210 during assembly of the first metal sheet 220, the adhesive film 210, and the housing 100 can be reduced, facilitating the positioning of the adhesive film 210 on the housing 100, enabling the adhesive film 210 to cover the first through hole 101, thus facilitating the assembly of the adhesive film 210, the first metal sheet 220, and the housing 100, and improving the sealing between the pressure relief mechanism 200 and the housing 100. By ensuring that the diameter D4 of the first metal sheet 220 is greater than or equal to the diameter D1 of the first through hole 101, the first metal sheet 220 can cover the first through hole 101, reducing the likelihood of water vapor infiltrating the interior of the housing 100 through the adhesive film 210 and the first through hole 101, thereby improving the sealing effect of the pressure relief mechanism 200.

In some other embodiments, the first through hole 101 may be configured in a racetrack shape, rectangular shape, or elliptical shape.

By configuring the first through hole 101 in a racetrack shape, rectangular shape, or elliptical shape, when a thickness of the electrochemical apparatus 10 is small, an area of the first through hole 101 is large, providing high pressure relief reliability.

In some other embodiments, the first metal sheet 220 may alternatively be configured in an elliptical shape, square shape, or the like. The adhesive film 210 may alternatively be configured in an elliptical shape, square shape, or the like.

In some other embodiments, the adhesive film 210 may alternatively be configured in an annular shape, eliminating the need to adjust the assembly direction of the adhesive film 210, facilitating the assembly between the adhesive film 210 and the housing 100; when the axis of the adhesive film 210 is aligned with the axis of the first through hole 101, the contact surface between the adhesive film 210 and the housing 100 is uniformly distributed, improving the sealing effect. Furthermore, when the adhesive film 210 melts or loses adhesion upon heating, first pressure relief channels can be formed both between the adhesive film 210 and the housing 100 and between the adhesive film 210 and the first metal sheet 220, increasing the number of first pressure relief channels, resulting in higher pressure relief sensitivity and better pressure relief effect.

In some other embodiments, the adhesive film 210 may alternatively be configured in an elliptical annular shape, square annular shape, or the like.

Referring to FIG. 2, in some embodiments, the pressure relief mechanism 200 may further include a second metal sheet 230, where the second metal sheet 230 is disposed between the adhesive film 210 and the housing 100, the second metal sheet 230 is welded to the housing 100, and the second metal sheet 230 is provided with a second through hole 231.

In some embodiments, the second metal sheet 230 may be made of materials such as aluminum, nickel, or stainless steel, which are resistant to rust and have a long service life.

In some embodiments, the welding method of the second metal sheet 230 to the housing 100 may be laser welding.

In some embodiments, the adhesive film 210 can be activated by high temperature to melt and adhere to the second metal sheet 230. After the adhesive film 210 cools down, it is fixed to the second metal sheet 230, which can seal the first through hole 101 and the second through hole 231. When the adhesive film 210 melts or loses adhesion again upon heating, it at least partially detaches from the second metal sheet 230 to form the first pressure relief channel.

By providing the second metal sheet 230 to be welded to the housing 100, the connection between the pressure relief mechanism 200 and the housing 100 can be more stable, and the sealing effect can be better.

Since the first through hole 101 is reused the electrolyte injection hole, residual electrolyte may remain at the electrolyte injection hole after the electrochemical apparatus 10 completes liquid injection, which may affect the adhesion of the adhesive film 210, making the adhesion between the adhesive film 210 and the housing 100 less secure; therefore, by providing the second metal sheet 230 to be welded to the housing 100, the connection between the pressure relief mechanism 200 and the housing 100 is further stabilized, the sealing effect can be better.

In some embodiments, the adhesive film 210 may first be adhered to the first metal sheet 220 and the second metal sheet 230 to form the pressure relief mechanism 200, the pressure relief mechanism 200 is then welded to the housing 100, which can make the preparation process simpler, and the pressure relief mechanism 200 can adapt to first through holes 101 of various sizes, providing good versatility.

In other embodiments, the first metal sheet 220, the adhesive film 210, and the second metal sheet 230 may be stacked first, and when the second metal sheet 230 is welded to the housing 100, the welding heat causes the adhesive film 210 to melt, simultaneously achieving adhesion of the adhesive film 210 to the first metal sheet 220 and the second metal sheet 230.

Referring to FIG. 2 and FIG. 4, in some embodiments, the second metal sheet 230 is configured in an annular shape, an outer diameter D2 of the second metal sheet 230 is greater than or equal to a diameter D1 of the first through hole 101, a diameter D4 of the first metal sheet 220 is less than or equal to the outer diameter D2 of the second metal sheet 230, and the diameter D4 of the first metal sheet 220 is greater than or equal to an inner diameter D3 of the second metal sheet 230.

By configuring the second metal sheet 230 to be annular, the second metal sheet 230 can form the first pressure relief channel, providing a good pressure relief effect for the pressure relief mechanism 200. By ensuring that the outer diameter D2 of the second metal sheet 230 is greater than or equal to the diameter D1 of the first through hole 101, it facilitates the welding of the second metal sheet 230 to the housing 100. By ensuring that the diameter D4 of the first metal sheet 220 is less than or equal to the outer diameter D2 of the second metal sheet 230, the likelihood of the first metal sheet 220 obstructing the second metal sheet 230 during assembly of the first metal sheet 220, the adhesive film 210, the second metal sheet 230, and the housing 100 is reduced, facilitating the positioning of the second metal sheet 230 on the housing 100, enabling the second metal sheet 230 to cover the first through hole 101, thus facilitating the assembly of the adhesive film 210, the first metal sheet 220, the second metal sheet 230, and the housing 100, and improving the sealing between the pressure relief mechanism 200 and the housing 100. By ensuring that the diameter D4 of the first metal sheet 220 is greater than or equal to the inner diameter D3 of the second metal sheet 230, the first metal sheet 220 can cover the second through hole 231, reducing the likelihood of water vapor infiltrating the interior of the housing 100 through the adhesive film 210 and the second through hole 231, thereby improving the sealing effect of the pressure relief mechanism 200.

In other embodiments, the second metal sheet 230 may also be configured in an elliptical annular shape, square annular shape, or the like.

In some embodiments, a diameter D1 of the first through hole 101, an outer diameter D2 of the second metal sheet 230, and an inner diameter D3 of the second metal sheet 230 meet 0.2 mm≤D1≤5 mm, 1 mm≤D2≤6 mm, and 0.1 mm≤D3≤ 3 mm. For example, D1 may be 0.2 mm, 3 mm, or 5 mm, D2 may be 1 mm, 4 mm, or 6 mm, and D3 may be 0.1 mm, 1.2 mm, or 3 mm.

The inner diameter D3 of the second metal sheet 230 is the diameter of the second through hole 231.

By setting the diameter D1 of the first through hole 101 to be between 0.2 mm and 5 mm, the first through hole 101 can provide a first pressure relief channel with a large cross-sectional area during thermal runaway of the electrochemical apparatus 10. Moreover, this avoids the need for a large-sized pressure relief mechanism 200 to cover the first through hole 101, facilitating the installation of the pressure relief mechanism 200 and reducing costs of the pressure relief mechanism 200. By setting the outer diameter D2 of the second metal sheet 230 to be between 1 mm and 6 mm, the second metal sheet 230 has sufficient area to adhere to the housing 100, which can facilitate the welding of the second metal sheet 230 to the housing 100, and the second metal sheet 230 does not extend beyond the housing 100, resulting in lower costs. By setting the inner diameter D3 of the second metal sheet 230 to be between 0.1 mm and 3 mm, the second through hole 231 can provide a first pressure relief channel with a large cross-sectional area when the first pressure relief channel is formed through the second through hole 231. Moreover, this avoids the need for a large-sized adhesive film 210 and first metal sheet 220 to cover the second through hole, facilitating the installation of the adhesive film 210 and the first metal sheet 220, and saving costs for the adhesive film 210 and the first metal sheet 220.

In some embodiments, the cross-sectional area of the first through hole 101 is an area of the cross-section of the first through hole 101 on a plane parallel to the radial direction of the first through hole 101. The second metal sheet 230 not protruding beyond the housing 100 means that the second metal sheet 230 does not extend beyond an edge of the housing 100 in the radial direction of the second metal sheet 230.

In some embodiments, the diameter D1 of the first through hole 101 meets 0.5 mm≤D1≤3 mm. For example, D1 may be 0.5 mm, 1.5 mm, or 3 mm. By setting the diameter D1 of the first through hole 101 to be between 0.5 mm and 3 mm, the first through hole 101 can further provide a first pressure relief channel with a large cross-sectional area during thermal runaway of the electrochemical apparatus 10. Moreover, this avoids the need for a large-sized pressure relief mechanism 200 to cover the first through hole 101, facilitating the installation of the pressure relief mechanism 200 and reducing costs of the pressure relief mechanism 200.

In some embodiments, the outer diameter D2 of the second metal sheet 230 meets 2 mm≤D2≤5 mm. For example, D2 may be 2 mm, 3 mm, or 5 mm. By setting the outer diameter D2 of the second metal sheet 230 to be between 2 mm and 5 mm, the second metal sheet 230 has sufficient area to adhere to the housing 100, further facilitating the welding of the second metal sheet 230 to the housing 100. Additionally, the second metal sheet 230 does not protrude beyond the housing 100, resulting in lower costs.

In some embodiments, the inner diameter D3 of the second metal sheet 230 meets 0.3 mm≤D3≤1.5 mm. For example, D3 may be 0.3 mm, 1 mm, or 1.5 mm. By setting the inner diameter D3 of the second metal sheet 230 to be between 0.3 mm and 1.5 mm, the second through hole 231 can further provide a first pressure relief channel with a large cross-sectional area when the first pressure relief channel is formed through the second through hole 231. Moreover, this avoids the need for a large-sized adhesive film 210 and first metal sheet 220 to cover the second through hole, facilitating the installation of the adhesive film 210 and the first metal sheet 220, and saving costs for the adhesive film 210 and the first metal sheet 220.

In some embodiments, a thickness H1 of the first metal sheet 220 and a thickness H2 of the second metal sheet 230 meet 0.03 mm≤H1≤1 mm, 0.03 mm≤ H2≤1 mm. For example, H1 may be 0.03 mm, 0.5 mm, or 1 mm, and H2 may be 0.03 mm, 0.4 mm, or 1 mm.

By setting the thickness H1 of the first metal sheet 220 to be between 0.03 mm and 1 mm and the thickness H2 of the second metal sheet 230 to be between 0.03 mm and 1 mm, the first metal sheet 220 and the second metal sheet 230 achieve a better sealing effect, reducing the likelihood of water vapor infiltrating the interior of the housing 100. Additionally, this can keep the thickness of the pressure relief mechanism 200 relatively small, thereby minimizing the space occupied by the pressure relief mechanism 200 in the length direction of the electrochemical apparatus 10. As a result, more space in the electrochemical apparatus 10 can be used for the electrode assembly 400, thereby facilitating an increase in the energy density of the electrochemical apparatus 10.

In some embodiments, the thickness H1 of the first metal sheet 220 meets 0.05 mm≤H1≤0.15 mm, and the thickness H2 of the second metal sheet 230 meets 0.05 mm≤H2≤0.15 mm. For example, H1 may be 0.05 mm, 0.1 mm, or 0.15 mm, and H2 may be 0.05 mm, 0.11 mm, or 0.15 mm. By setting the thickness H1 of the first metal sheet 220 to be between 0.05 mm and 0.15 mm and the thickness H2 of the second metal sheet 230 to be between 0.05 mm and 0.15 mm, the first metal sheet 220 and the second metal sheet 230 can further achieve a better sealing effect, reducing the likelihood of water vapor infiltrating the interior of the housing 100. Additionally, this can keep the thickness of the pressure relief mechanism 200 relatively small, thereby minimizing the space occupied by the pressure relief mechanism 200 in the length direction of the electrochemical apparatus 10, allowing more space in the electrochemical apparatus 10 for the electrode assembly 400, and facilitating an increase in the energy density of the electrochemical apparatus 10.

In some embodiments, a thickness H3 of the adhesive film 210 meets 0.05 mm≤H3≤1 mm. For example, H3 may be 0.05 mm, 0.4 mm, or 1 mm.

By setting the thickness H3 of the adhesive film 210 to be between 0.05 mm and 1 mm, the adhesive film 210 is less likely to be damaged, has low water permeability, and is easily melted or loses adhesion upon high temperature to form the first pressure relief channel, resulting in high pressure relief sensitivity and good pressure relief effect for the pressure relief mechanism 200. At room temperature, the adhesive film 210 has strong adhesion to the first metal sheet 220 and the second metal sheet 230, providing a good sealing effect for the first through hole 101.

In some embodiments, the thickness H3 of the adhesive film 210 meets 0.1 mm<H3<0.3 mm. For example, H3 may be 0.1 mm, 0.2 mm, or 0.3 mm. By setting the thickness H3 of the adhesive film 210 to be between 0.1 mm and 0.3 mm, the adhesive film 210 is further less likely to be damaged, has lower water permeability, and is more easily melted or loses adhesion upon high temperature to form the first pressure relief channel, resulting in higher pressure relief sensitivity and better pressure relief effect for the pressure relief mechanism 200. At room temperature, the adhesive film 210 has stronger adhesion to the first metal sheet 220 and the second metal sheet 230, providing a better sealing effect for the first through hole 101.

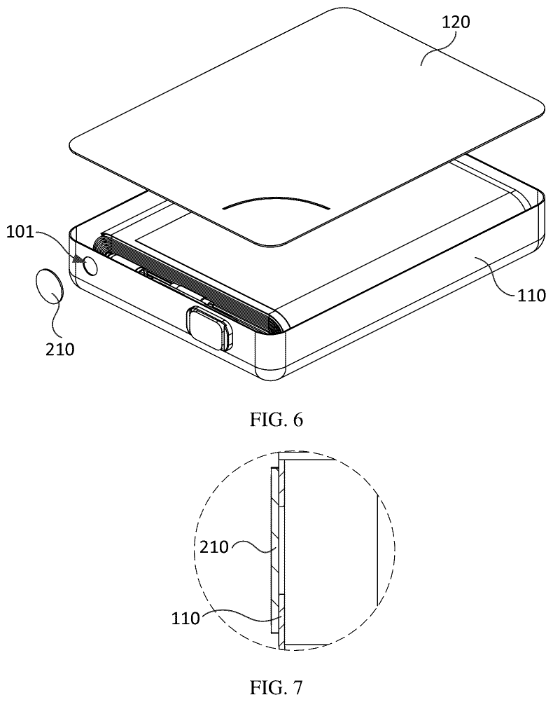

Referring to FIG. 6 and FIG. 7, FIG. 6 is a schematic perspective view of a structure of an electrochemical apparatus according to some other embodiments of the present application, and FIG. 7 is a schematic cross-sectional view of a structure of a portion of the electrochemical apparatus according to the embodiment of FIG. 6.

In some other embodiments, the pressure relief mechanism 200 may include only the adhesive film 210, where the adhesive film 210 is capable of melting or losing adhesion when heated to form a first pressure relief channel connecting the interior and exterior of the housing 100, enabling the electrochemical apparatus 10 to relieve pressure through the pressure relief mechanism 200 when the temperature is high, resulting in high pressure relief sensitivity and pressure relief reliability of the electrochemical apparatus 10, and reducing the probability of thermal runaway in the electrochemical apparatus 10.

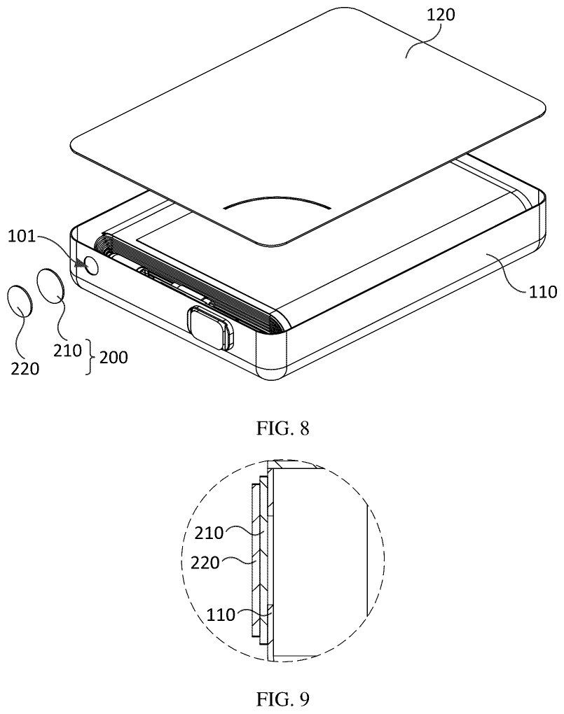

Referring to FIG. 8 and FIG. 9, FIG. 8 is a schematic perspective view of a structure of an electrochemical apparatus according to some other embodiments of the present application, and FIG. 9 is a schematic cross-sectional view of a structure of a portion of the electrochemical apparatus according to the embodiment of FIG. 8.

In some other embodiments, the pressure relief mechanism 200 may include only the adhesive film 210 and the first metal sheet 220, where the adhesive film 210 is capable of melting or losing adhesion when heated to form a first pressure relief channel connecting the interior and exterior of the housing 100, enabling the electrochemical apparatus 10 to relieve pressure through the pressure relief mechanism 200 when the temperature is high, resulting in high pressure relief sensitivity and pressure relief reliability of the electrochemical apparatus 10, and reducing the probability of thermal runaway in the electrochemical apparatus 10. The first metal sheet 220 can reduce the water seepage area of the adhesive film 210, improving the sealing effect, thereby extending the service life of the electrochemical apparatus 10.

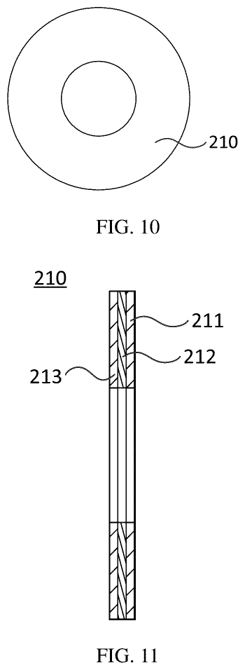

Referring to FIG. 2, FIG. 10, and FIG. 11, FIG. 10 is a schematic diagram of a structure of an adhesive film of an electrochemical apparatus from one perspective according to some embodiments of the present application, and FIG. 11 is a schematic cross-sectional view of a structure of an adhesive film of an electrochemical apparatus from another perspective according to some embodiments of the present application.

In some embodiments, the adhesive film 210 includes a first adhesive layer 211, a second adhesive layer 212, and a third adhesive layer 213, where the second adhesive layer 212, the first adhesive layer 211, and the third adhesive layer 213 are sequentially stacked, the second adhesive layer 212 is located on a side of the first adhesive layer 211 facing away from the housing 100, a melting point of the first adhesive layer 211 is lower than a melting point of the second adhesive layer 212, the third adhesive layer 213 is located between the second adhesive layer 212 and the first metal sheet 220, and a melting point of the third adhesive layer 213 is lower than the melting point of the second adhesive layer 212.

In some embodiments, the second adhesive layer 212, the first adhesive layer 211, and the third adhesive layer 213 are stacked along the thickness direction of the adhesive film 210. By ensuring that the melting point of the first adhesive layer 211 is less than that of the second adhesive layer 212 and the melting point of the third adhesive layer 213 is less than that of the second adhesive layer 212, when the adhesive film 210 is activated by high temperature, the first adhesive layer 211 can melt to adhere to the housing 100, and the third adhesive layer 213 can melt to adhere to the first metal sheet 220, while the second adhesive layer 212 does not melt, which can prevent excessive melting of the adhesive film 210 that could affect the installation of the adhesive film 210 and can also reduce the amount of adhesive overflow. During thermal runaway of the electrochemical apparatus 10, the first adhesive layer 211 in contact with the housing 100 and the third adhesive layer 213 in contact with the first metal sheet 220 can each form a first pressure relief channel, compared to having only one first pressure relief channel, this embodiment provides higher pressure relief reliability for the pressure relief mechanism 200, which can reduce the likelihood of the first pressure relief channel failing to form. Additionally, when both first pressure relief channels are opened simultaneously, the pressure relief speed of the pressure relief mechanism 200 is increased. Therefore, the three-layer structure of the adhesive film 210 can improve the pressure relief sensitivity and pressure relief reliability of the electrochemical apparatus 10, and reduce the probability of thermal runaway of the electrochemical apparatus 10.

In some embodiments, a melting point T1 of the first adhesive layer 211, a melting point T2 of the second adhesive layer 212, and a melting point T3 of the third adhesive layer 213 meet 95° C. ≤T1≤135° C., 140° C. ≤T2≤190° C., and 95° C. ≤T3≤ 135° C. For example, T1 may be 95° C., 100° C., or 135° C., T2 may be 140° C., 150° C., or 190° C., and T3 may be 95° C., 110° C., or 135° C.

By setting the melting point T1 of the first adhesive layer 211 to be between 95° C. and 135° C., the melting point T2 of the second adhesive layer 212 to be between 140° C. and 190° C., and the melting point T3 of the third adhesive layer 213 to be between 95° C. and 135° C., the adhesive film 210 can achieve high sealing reliability for the first through hole 101, and the first adhesive layer 211 can melt before the second adhesive layer 212, facilitating installation on the housing 100 when the adhesive film 210 is activated by high temperature, and the third adhesive layer 213 can melt before the second adhesive layer 212, facilitating installation on the first metal sheet 220 when the adhesive film 210 is activated by high temperature. During thermal runaway of the electrochemical apparatus 10, the first adhesive layer 211 can melt or lose adhesion before the second adhesive layer 212 to form a first pressure relief channel, and the third adhesive layer 213 can melt or lose adhesion before the second adhesive layer 212 to form a first pressure relief channel, resulting in high pressure relief sensitivity of the electrochemical apparatus 10 and reducing the amount of adhesive overflow of the adhesive film 210.

In some other embodiments, the adhesive film 210 may have a single-layer structure, with a melting point T of the adhesive film 210 meeting 95° C. ≤T≤135° C. For example, T may be 95° C., 120° C., or 135° C.

By setting the melting point T of the adhesive film 210 to be between 95° C. and 135° C., the adhesive film 210 can achieve high sealing reliability for the first through hole 101, and during thermal runaway of the electrochemical apparatus 10, the adhesive film 210 can melt or lose adhesion to form the first pressure relief channel, resulting in high pressure relief sensitivity of the electrochemical apparatus 10.

In some other embodiments, the adhesive film 210 may have a double-layer structure, including a first adhesive layer 211 and a second adhesive layer 212, where the first adhesive layer 211 and the second adhesive layer 212 are stacked, the second adhesive layer 212 is located on a side of the first adhesive layer 211 facing away from the housing 100, and a melting point of the first adhesive layer 211 is lower than a melting point of the second adhesive layer 212.

By configuring the adhesive film 210 with a double-layer structure, including the first adhesive layer 211 and the second adhesive layer 212, and ensuring that the melting point of the first adhesive layer 211 is less than that of the second adhesive layer 212, when the adhesive film 210 is activated by high temperature, the first adhesive layer 211 can melt to adhere to the housing 100, while the second adhesive layer 212 does not melt, which can prevent excessive melting of the adhesive film 210 that could affect the installation of the adhesive film 210 and can also reduce the amount of adhesive overflow of the adhesive film 210.

In some embodiments, a melting point T1 of the first adhesive layer 211 and a melting point T2 of the second adhesive layer 212 meet 95° C. ≤T1≤135° C., and 140° C. ≤T2≤190° C. For example, T1 may be 95° C., 100° C., or 135° C., and T2 may be 140° C., 150° C., or 190° C.

In some embodiments, the housing 100 may be provided with a groove (not shown in the figures), the first through hole 101 extends through the groove, and the pressure relief mechanism 200 is accommodated in the groove.

By providing a groove in the housing 100, with the first through hole 101 extending through the groove and the pressure relief mechanism 200 accommodated in the groove, the portion of the pressure relief mechanism 200 protruding beyond the outer surface of the housing has a small thickness, which can reduce the likelihood of the pressure relief mechanism 200 being damaged or detached from the housing 100 due to interference with other components.

In some embodiments, the pressure relief mechanism 200 does not protrude beyond the outer surface of the housing, which can further reduce the likelihood of the pressure relief mechanism 200 being damaged or detached from the housing 100 due to interference with other components.

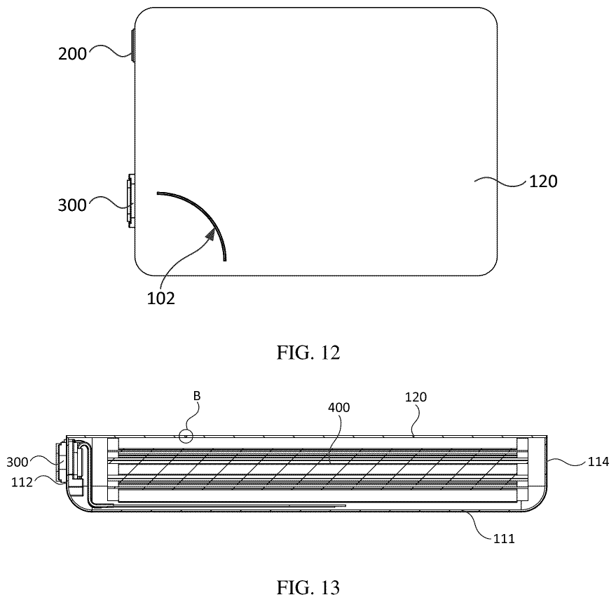

Referring to FIG. 1, FIG. 2, FIG. 12, and FIG. 13, FIG. 12 is a schematic diagram of a structure of an electrochemical apparatus from one perspective according to some embodiments of the present application, and FIG. 13 is a schematic cross-sectional view of a structure of an electrochemical apparatus from another perspective according to some embodiments of the present application.

In some embodiments, the housing 100 includes a shell 110 and a shell cover 120, where the shell 110 includes a bottom wall 111 and a plurality of side walls surrounding the bottom wall 111, the bottom wall 111 and the plurality of side walls together form an accommodation space with an opening, the shell cover 120 seals the opening, the side wall is the first wall, and the bottom wall 111 or the shell cover 120 is the second wall.

In some embodiments, the shell cover 120 is plate-shaped, and the shell cover 120 seals the opening formed by the shell 110.

In some other embodiments, the shell cover 120 may alternatively be a hollow structure with an opening at one end, where the opening side of the shell cover 120 is fitted with the opening side of the shell 110 to form the accommodation space. The score groove 102 may be disposed on a wall of the shell cover 120 opposite the bottom wall 111.

In some embodiments, the shell 110 and the shell cover 120 may be made of materials such as aluminum, nickel, or stainless steel, providing the housing 100 with high mechanical strength, resistance to rust, and a long service life.

In some embodiments, the shell 110, the shell cover 120, and the second metal sheet 230 may be made of the same metal material, facilitating the welding of the shell 110 to the shell cover 120 and the welding of the shell 110 to the second metal sheet 230.

In some embodiments, the shell 110 and the shell cover 120 may be fixedly connected by laser welding.

By disposing the first through hole 101 on the side wall of the shell 110, the likelihood of the first pressure relief channel being obstructed can be reduced, and the pressure relief reliability of the pressure relief mechanism 200 is high. By disposing the score groove 102 on the bottom wall 111 or the shell cover 120 of the shell 110, a larger second pressure relief channel can be formed, facilitating rapid discharge of gas inside the housing 100, and providing high pressure relief reliability.

In some embodiments, the side wall of the shell 110 may be provided with a plurality of first through holes 101, where the plurality of first through holes 101 are spaced apart. By providing a plurality of first through holes 101, the pressure relief sensitivity and pressure relief reliability of the electrochemical apparatus 10 can be further improved, the pressure relief speed can be increased, and the probability of thermal runaway in the electrochemical apparatus 10 can be further reduced.

In some embodiments, each first through hole 101 may be provided with an adhesive film 210, the adhesive film 210 covers the first through hole 101, and the melting points of the plurality of adhesive films 210 may be different to automatically adjust the pressure relief speed when the temperature of the electrochemical apparatus 10 is high. For example, when the temperature of the electrochemical apparatus 10 reaches the melting point of the adhesive film 210 with the lowest melting point, that adhesive film 210 melts or loses adhesion to form a first pressure relief channel, with a slower pressure relief speed, and as the temperature of the electrochemical apparatus 10 continues to rise, other adhesive films 210 sequentially melt or lose adhesion to form additional first pressure relief channels, increasing the pressure relief speed. That is, a higher temperature of the electrochemical apparatus 10 indicates a faster pressure relief speed of the electrochemical apparatus 10, which can further reduce the likelihood of thermal runaway in the electrochemical apparatus 10.

In some embodiments, the bottom wall 111 and/or the shell cover 120 may be provided with a plurality of score grooves 102, where the plurality of score grooves 102 are spaced apart. By providing a plurality of score grooves 102, the pressure relief sensitivity and pressure relief reliability of the electrochemical apparatus 10 can be further improved, the pressure relief speed can be increased, the probability of thermal runaway in the electrochemical apparatus 10 can be further reduced.

For example, the shell cover 120 is provided with two score grooves 102, where the two score grooves 102 are respectively disposed at two top corners of the shell cover 120 near the terminal post 300 and arranged symmetrically, which can ensure that when gas inside the housing 100 is discharged through the pressure relief openings formed by the rupture of the two score grooves 102, the shell cover 120 experiences force more evenly and is less likely to deform significantly to squeeze other devices.

In some embodiments, the bottom wall 111 and the shell cover 120 may be two surfaces with the largest area on the outer surface of the electrochemical apparatus 10; when the internal pressure of the electrochemical apparatus 10 is high, the bottom wall 111 and the shell cover 120 are prone to deformation, so disposing the score groove 102 on the bottom wall 111 or the shell cover 120 makes the score groove 102 more likely to rupture when the internal pressure of the electrochemical apparatus 10 is high. Furthermore, by forming the first pressure relief channel through the pressure relief mechanism 200 and the second pressure relief channel through the score groove 102, the amount of gas discharged through the second pressure relief channel can be reduced. As a result, the bottom wall 111 or the shell cover 120 where the score groove 102 is located is less subjected to pressure, reducing the likelihood of significant deformation, thereby reducing the risk of squeezing other devices.

In some embodiments, the plurality of side walls may include a first side wall 112, a second side wall 113, a third side wall 114, and a fourth side wall 115, where the first side wall 112 is opposite the third side wall 114, the second side wall 113 is opposite the fourth side wall 115, the first side wall 112 is connected to the second side wall 113 and the fourth side wall 115, separately, and the third side wall 114 is connected to the second side wall 113 and the fourth side wall 115, separately. The electrochemical apparatus 10 further includes a terminal post 300, where the terminal post 300 and the first through hole 101 are disposed on the same side wall (for example, the first side wall 112).

In some other embodiments, the terminal post 300 and the first through hole 101 may be disposed on different side walls. For example, the terminal post 300 is disposed on the first side wall 112, and the first through hole 101 is disposed on the second side wall 113.

Since the terminal post 300 can be used to connect to a circuit board (not shown in the figures), by disposing the terminal post 300 and the first through hole 101 on different side walls, after the pressure relief mechanism 200 forms the first pressure relief channel, the electrolyte inside the electrochemical apparatus 10 can be less likely to spray onto the circuit board through the first pressure relief channel, reducing the likelihood of the electrolyte causing a short circuit in the components on the circuit board.

In some embodiments, the terminal post 300 and the first through hole 101 are disposed on different side walls, and the first through hole 101 is disposed near the terminal post 300, enabling gas inside the housing 100 to be discharged through the clearance space formed between the electrode assembly 400 and the housing 100 and the first pressure relief channel formed by the pressure relief mechanism 200, providing high pressure relief reliability.

In some embodiments, the terminal post 300 may be fixedly disposed on the side wall of the housing 100 by riveting, welding, or other methods.

On the side of the electrochemical apparatus 10 where the terminal post 300 is disposed, a clearance space is formed between the electrode assembly 400 and the housing 100. By disposing the terminal post 300 and the first through hole 101 on the same side wall, gas inside the housing 100 can be discharged through the clearance space and the first through hole 101, providing high pressure relief reliability. Furthermore, since space needs to be reserved for the terminal post 300 to electrically connect to other devices of the electric device when the electrochemical apparatus 10 is installed in the electric device, disposing the terminal post 300 and the first through hole 101 on the same side wall eliminates the need to reserve additional space for the pressure relief mechanism 200 to achieve pressure relief, and the first side wall 112 may be the side wall with the smallest area among the plurality of side walls of the shell 110, requiring less clearance space, further saving space in the electric device and making the structure of the electric device more compact.

In some embodiments, the score groove 102 is disposed in a corner of the housing 100.

In some embodiments, the housing 100 is configured in a rectangular shape, and the corners of the housing 100 are the four top corners of the housing 100.

When the internal pressure of the housing 100 increases, the bottom wall 111 or the shell cover 120 where the score groove 102 is located deforms. The corners of the housing 100 are stress concentration regions of the housing 100, and by disposing the score groove 102 in a corner of the housing 100, when the stress exceeds the tensile strength of the material of the bottom wall 111 or the shell cover 120 where the score groove 102 is located, the score groove 102 is more likely to rupture to form a pressure relief opening, providing higher pressure relief reliability.

In some embodiments, the score groove 102 is disposed near an end of the housing 100 where the terminal post 300 is located.

On the side of the electrochemical apparatus 10 where the terminal post is disposed, a clearance space is formed between the electrode assembly 400 and the housing 100. By disposing the score groove 102 near the end of the housing 100 where the terminal post 300 is located, gas inside the housing 100 can be discharged through the clearance space and a pressure relief opening formed by the rupture of the score groove 102, reducing the likelihood of the electrode assembly 400 obstructing the pressure relief opening formed by the rupture of the score groove 102, and providing high pressure relief reliability. Furthermore, there is no need to reserve space between the electrode assembly 400 and the bottom wall 111 or the shell cover 120 where the score groove 102 is located to avoid the electrode assembly 400 obstructing the pressure relief opening formed by the rupture of the score groove 102, which can increase the volume of the electrode assembly 400 and increase the energy density of the electrochemical apparatus 10.

In some embodiments, the score groove 102 is disposed at the top corner of the housing 100 closest to the terminal post 300, while the first through hole 101 is located on the first side wall 112 where the terminal post 300 is disposed and near another top corner of the housing 100; the pressure relief mechanism 200 and the score groove 102 are respectively located at opposite ends of the housing 100 along the width direction, maintaining a certain distance, so that when both the first pressure relief channel and the second pressure relief channel are opened, gas can be discharged from both ends of the housing 100 along the width direction, rather than being concentrated at one top corner of the housing 100, reducing the likelihood of significant localized stress causing deformation of the housing 100.

In some embodiments, the score groove 102 is configured in an arc shape and bends toward the center of the shell cover 120 or the bottom wall 111 where the score groove 102 is located.

In some embodiments, the score groove 102 may be configured in a C-shape or other arc shapes.

Compared to configuring the score groove 102 in an L-shape or V-shape, where bending occurs during etching that easily cause discontinuous etching or deviations of the score groove 102, configuring the score groove 102 in an arc shape makes the etching process of the score groove 102 more continuous, facilitating the processing and formation of the score groove 102. Since the central portion of the shell cover 120 or the bottom wall 111 is subjected to greater force and is more prone to deformation when the internal pressure of the electrochemical apparatus 10 is high, by configuring the score groove 102 to bend toward the center of the shell cover 120 or the bottom wall 111 where the score groove 102 is located, the score groove 102 can be brought closer to the center of the shell cover 120 or the bottom wall 111 where the score groove 102 is located, making the score groove 102 more likely to rupture and form a larger pressure relief opening, facilitating rapid discharge of gas inside the housing 100, and providing high pressure relief reliability.

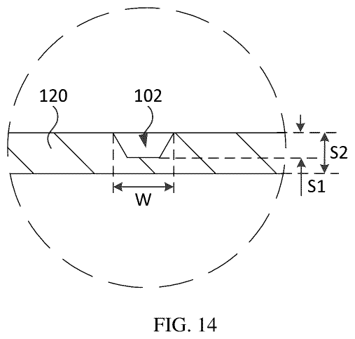

Referring to FIG. 14, FIG. 14 is a schematic partial enlarged view of a structure at B of the electrochemical apparatus shown in FIG. 13.

In some embodiments, a width of the score groove 102 gradually decreases in a direction toward the interior of the housing 100.

By configuring the width of the score groove 102 to gradually decrease in the direction toward the interior of the housing 100, the processing cost of the score groove 102 can be reduced, and since a larger volume of the score groove 102 makes the shell cover 120 or the bottom wall 111 where the score groove 102 is located more susceptible to thermal deformation, configuring the width of the score groove 102 to gradually decrease in the direction toward the interior of the housing 100 can also reduce the likelihood of thermal deformation of the shell cover 120 or the bottom wall 111 where the score groove 102 is located.

In some embodiments, a cross-section of the score groove 102 may be configured in an inverted trapezoid shape.

In some other embodiments, the cross-section of the score groove 102 may alternatively be configured in a V-shape, U-shape, or the like.

The cross-section of the score groove 102 is a section of the score groove 102 in a direction perpendicular to its extension direction.

In some embodiments, a maximum width of the score groove 102 is denoted as W, meeting 0.02 mm≤W≤0.5 mm. For example, W may be 0.02 mm, 0.2 mm, or 0.5 mm.

By setting the maximum width W of the score groove 102 to be between 0.02 mm and 0.5 mm, the score groove 102 can easily rupture when the internal pressure of the housing 100 is high, providing high pressure relief reliability, and the score groove 102 has a low cost and is less likely to rupture when the electrochemical apparatus 10 is dropped or subjected to external forces.

In some embodiments, 0.05 mm≤W≤0.2 mm. For example, W may be 0.05 mm, 0.1 mm, or 0.2 mm.

By setting the maximum width W of the score groove 102 to be between 0.05 mm and 0.2 mm, the score groove 102 can more easily rupture when the internal pressure of the housing 100 is high, providing higher pressure relief reliability, and the score groove 102 has a lower cost and is less likely to rupture when the electrochemical apparatus 10 is dropped or subjected to external forces.

In some embodiments, 0.06 mm≤W≤0.18 mm. For example, W may be 0.06 mm, 0.12 mm, or 0.18 mm.

By setting the maximum width W of the score groove 102 to be between 0.06 mm and 0.18 mm, the score groove 102 can more easily rupture when the internal pressure of the housing 100 is high, providing higher pressure relief reliability, and the score groove 102 has a lower cost and is less likely to rupture when the electrochemical apparatus 10 is dropped or subjected to external forces. By integrating the thermal melting pressure relief (pressure relief mechanism 200) and the score groove 102 into the housing 100 of the same electrochemical apparatus 10, the maximum width W of the score groove 102 can be set to be between 0.06 mm and 0.18 mm.

In some embodiments, a thickness S2 of the second wall meets 0.03 mm≤ S2≤0.3 mm. For example, S2 may be 0.03 mm, 0.2 mm, or 0.3 mm.

By setting the thickness S2 of the second wall to be between 0.03 mm and 0.3 mm, the second wall can be less likely to deform under force or heat, and the space occupied by the second wall is small, which contributes to increasing the energy density of the electrochemical apparatus 10.

Referring to Table 1, Table 1 shows a comparison of the hot chamber test pass rate and the drop test pass rate for a plurality of examples of an electrochemical apparatus with only a score groove and a plurality of examples of an electrochemical apparatus with both a score groove and a pressure relief mechanism according to the present application. The tests are conducted with the score groove 102 disposed on the shell cover 120 as an example. In Table 1, S1 is the depth of the score groove 102, S2 is the thickness of the shell cover 120 where the score groove 102 is located, and W is the maximum width of the score groove 102. The units of the depth of the score groove 102, the thickness of the shell cover 120, and the maximum width of the score groove 102 are all in millimeters.

The method for the hot chamber test is as follows:
(1) The electrochemical apparatus was fully discharged in an environment of 23±2° C., and then fully charged.
(2) The electrochemical apparatus was photographed and the OCV (Open Circuit Voltage, open circuit voltage) and impedance of the electrochemical apparatus were recorded.
(3) The electrochemical apparatus was placed in an oven at 23° C. until the temperature of the electrochemical apparatus stabilized.
(4) A temperature sensing wire was attached near the negative electrode tab of the electrochemical apparatus.
(5) The OCV measurement cable was connected to the electrochemical apparatus and the oven was closed.
(6) The temperature of the oven was increased from an initial temperature of 23±2° C. at a rate of 5±2° C./min until the temperature of the oven reached 130±2° C., and then the temperature of the oven was maintained at 130±2° C. for 60 minutes.
(7) If the electrochemical apparatus did not experience phenomena such as explosion, smoke emission, or ignition, the test was passed.

The method for the drop test is as follows:
(1) The electrochemical apparatus was fully charged in an environment of 23±2° C.
(2) The electrochemical apparatus was photographed and the OCV (Open Circuit Voltage, open circuit voltage) and impedance of the electrochemical apparatus were recorded.
(3) Six surfaces and four top corners of the electrochemical apparatus were respectively placed facing downward, and the apparatus was freely dropped from a height of 1.5 meters onto a concrete surface, where the height referred to a distance from the lowest point of the electrochemical apparatus to the concrete surface.
(4) The electrochemical apparatus was left standing for 1 hour and observations were made to check whether phenomena such as explosion, smoke emission, or ignition occurred.
(5) After the electrochemical apparatus was left standing for 12 hours, the OCV of the electrochemical apparatus was tested to see if it was greater than or equal to 90% of the initial OCV value before the drop.
(6) If the electrochemical apparatus did not experience phenomena such as explosion, smoke emission, or ignition, and the OCV of the electrochemical apparatus is greater than or equal to 90% of the initial OCV value before the drop, the test was passed.

From the test results in Table 1, it can be seen that:

1. From Comparative Examples 1 to 4, it can be seen that for an electrochemical apparatus with only a score groove for pressure relief, a greater depth S1 of the score groove indicates a higher hot chamber test pass rate, but a lower drop test pass rate.

2. From Examples 1 to 3, it can be seen that for an electrochemical apparatus with both a pressure relief mechanism and a score groove for pressure relief, when the maximum width W of the score groove is 0.2 mm and the depth S1 of the score groove is 0.01 mm to 0.05 mm, a greater depth S1 of the score groove indicates a higher hot chamber test pass rate and a high drop test pass rate.

3. From Examples 3 to 7, it can be seen that for an electrochemical apparatus with both a pressure relief mechanism and a score groove for pressure relief, when the maximum width W of the score groove is 0.2 mm and the depth S1 of the score groove is 0.05 mm to 0.07 mm, both the hot chamber test pass rate and the drop test pass rate are high.

TABLE 1
Hot chamber test pass rate and drop test
pass rate of electrochemical apparatuses

| | | | | Whether | | |
|---|---|---|---|---|---|---|
| | | | | pressure | | |
| | | | | relief | Hot | |
| | | | | mechanism | chamber | |
| | | | | is | test pass | Drop test |
| | S1 | S2 | W | configured | rate | pass rate |
| Comparative | 0.05 | 0.1 | 0.2 | No | 40% | 100% |
| Example 1 | | | | | | |
| Comparative | 0.065 | 0.1 | 0.2 | No | 70% | 100% |
| Example 2 | | | | | | |
| Comparative | 0.08 | 0.1 | 0.2 | No | 80% | 80% |
| Example 3 | | | | | | |
| Comparative | 0.095 | 0.1 | 0.2 | No | 100% | 20% |
| Example 4 | | | | | | |
| Comparative | 0.07 | 0.1 | 0.02 | No | 65% | 100% |
| Example 5 | | | | | | |
| Comparative | 0.07 | 0.1 | 0.05 | No | 70% | 100% |
| Example 6 | | | | | | |
| Comparative | 0.07 | 0.1 | 0.06 | No | 70% | 100% |
| Example 7 | | | | | | |
| Comparative | 0.07 | 0.1 | 0.18 | No | 75% | 100% |
| Example 8 | | | | | | |
| Comparative | 0.07 | 0.1 | 0.2 | No | 75% | 100% |
| Example 9 | | | | | | |
| Comparative | 0.07 | 0.1 | 0.5 | No | 75% | 100% |
| Example 10 | | | | | | |
| Example 1 | 0.01 | 0.1 | 0.2 | Yes | 70% | 100% |
| Example 2 | 0.04 | 0.1 | 0.2 | Yes | 90% | 100% |
| Example 3 | 0.05 | 0.1 | 0.2 | Yes | 100% | 100% |
| Example 4 | 0.055 | 0.1 | 0.2 | Yes | 100% | 100% |
| Example 5 | 0.06 | 0.1 | 0.2 | Yes | 100% | 100% |
| Example 6 | 0.065 | 0.1 | 0.2 | Yes | 100% | 100% |
| Example 7 | 0.07 | 0.1 | 0.2 | Yes | 100% | 100% |
| Example 8 | 0.075 | 0.1 | 0.2 | Yes | 100% | 90% |
| Example 9 | 0.08 | 0.1 | 0.2 | Yes | 100% | 80% |
| Example 10 | 0.095 | 0.1 | 0.2 | Yes | 100% | 20% |
| Example 11 | 0.07 | 0.1 | 0.02 | Yes | 100% | 100% |
| Example 12 | 0.07 | 0.1 | 0.05 | Yes | 100% | 100% |
| Example 13 | 0.07 | 0.1 | 0.06 | Yes | 100% | 100% |
| Example 14 | 0.07 | 0.1 | 0.18 | Yes | 100% | 100% |
| Example 15 | 0.07 | 0.1 | 0.2 | Yes | 100% | 100% |
| Example 16 | 0.07 | 0.1 | 0.5 | Yes | 100% | 100% |

4. From Examples 7 to 10, it can be seen that for an electrochemical apparatus with both a pressure relief mechanism and a score groove for pressure relief, when the maximum width W of the score groove is 0.2 mm and the depth S1 of the score groove is 0.07 mm to 0.095 mm, a greater depth S1 of the score groove indicates a lower drop test pass rate, but a high hot chamber test pass rate.

5. The electrochemical apparatuses of Comparative Example 2 and Example 1 both achieve a hot chamber test pass rate of 70% and the same drop test pass rate, but the depth of the score groove in the electrochemical apparatus with only a score groove 10 for pressure relief is 0.065 mm, while the depth of the score groove in the electrochemical apparatus with both a pressure relief mechanism and a score groove in the present application is 0.01 mm. Therefore, the electrochemical apparatus with both a pressure relief mechanism and a score groove in the present application can achieve the same pressure relief effect while reducing the cost of the score groove.

6. From Comparative Examples 5 to 8, it can be seen that for an electrochemical apparatus with only a score groove for pressure relief, a greater maximum width W of the score groove indicates a higher hot chamber test pass rate.

7. From Comparative Examples 6 to 10 and Example 11, the maximum width of the score groove in the electrochemical apparatus with only a score groove for pressure relief is 0.05 mm to 0.5 mm, while the maximum width of the score groove in the electrochemical apparatus with both a pressure relief mechanism and a score groove in the present application is 0.02 mm. This design can reduce the cost of the score groove, increase the hot chamber test pass rate, and maintain the drop test pass rate.

8. From Comparative Example 1 and Example 3, Comparative Example 2 and Example 6, Comparative Example 3 and Example 9, and Comparative Examples 5 to 10 and Examples 11 to 16, compared to an electrochemical apparatus with only a score groove for pressure relief, the electrochemical apparatus with both a pressure relief mechanism and a score groove for pressure relief in the present application can increase the hot chamber test pass rate without decreasing the drop test pass rate.

The present application further provides an electric device including the electrochemical apparatus 10 provided in any of the above embodiments, where the electrochemical apparatus 10 is configured to provide electrical energy.

The electric device may be any device or apparatus using the electrochemical apparatus 10 described above.

It should be noted that, in the absence of conflict, some embodiments and features in these embodiments of the present application may be combined with each other.

The above are only preferred embodiments of the present application and are not intended to limit the present application. For those skilled in the art, various modifications and changes may be made to the present application. Any modifications, equivalent substitutions, improvements, and the like made within the spirit and principles of the present application shall be included within the scope of protection of the present application.

What is claimed is:

1. An electrochemical apparatus, comprising:
a housing comprising a first wall and a second wall, wherein the first wall is provided with a first through hole; and
a pressure relief mechanism covering the first through hole, wherein the pressure relief mechanism comprises an adhesive film, and the adhesive film is configured to melt or lose adhesion when heated to form a first pressure relief channel connecting an interior of the housing to an exterior of the housing; wherein
the second wall is provided with a score groove, and the score groove is configured to rupture when an internal pressure of the housing reaches a threshold to form a second pressure relief channel connecting the interior of the housing to the exterior of the housing; and
a depth of the score groove is denoted as S1, and a thickness of the second wall is denoted as S2, wherein 0.1*S2≤S1≤0.95*S2.

2. The electrochemical apparatus according to claim 1, wherein 0.4*S2≤S1≤ 0.8*S2.

3. The electrochemical apparatus according to claim 1, wherein 0.55*S2≤S1≤ 0.8*S2.

4. The electrochemical apparatus according to claim 1, wherein the pressure relief mechanism further comprises a first metal sheet, wherein the first metal sheet is disposed on a side of the adhesive film facing away from the housing.

5. The electrochemical apparatus according to claim 4, wherein the first metal sheet is in a circular shape, the adhesive film is in circular or annular shape, the first through hole is in a circular shape, a diameter of the first metal sheet is less than or equal to an outer diameter of the adhesive film, and the diameter of the first metal sheet is greater than or equal to a diameter of the first through hole.

6. The electrochemical apparatus according to claim 4, wherein the pressure relief mechanism further comprises a second metal sheet, wherein the second metal sheet is disposed between the adhesive film and the housing, the second metal sheet is welded to the housing, and the second metal sheet is provided with a second through hole.

7. The electrochemical apparatus according to claim 6, wherein the first metal sheet is circular, the first through hole is in a circular shape, the second metal sheet is in an annular shape, an outer diameter of the second metal sheet is greater than or equal to the diameter of the first through hole, the diameter of the first metal sheet is less than or equal to the outer diameter of the second metal sheet, and the diameter of the first metal sheet is greater than or equal to an inner diameter of the second metal sheet.

8. The electrochemical apparatus according to claim 6, wherein the first through hole is in a circular shape, a diameter of the first through hole is denoted as D1, the second metal sheet is annular, an outer diameter of the second metal sheet is denoted as D2, and an inner diameter of the second metal sheet is denoted as D3, wherein 0.2 mm ≤D1≤5 mm, 1 mm≤D2≤6 mm, 0.1 mm≤D3≤3 mm.

9. The electrochemical apparatus according to claim 6, wherein a thickness of the first metal sheet is denoted as H1, and a thickness of the second metal sheet is denoted as H2, wherein 0.03 mm≤H1≤1 mm and 0.03 mm≤H2≤1 mm.

10. The electrochemical apparatus according to claim 1, wherein a melting point of the adhesive film is denoted as T, and 95° C. ≤T≤135° C.

11. The electrochemical apparatus according to claim 1, wherein the adhesive film comprises a first adhesive layer and a second adhesive layer, wherein the first adhesive layer and the second adhesive layer are stacked, the second adhesive layer is located on a side of the first adhesive layer facing away from the housing, and a melting point of the first adhesive layer is lower than a melting point of the second adhesive layer.

12. The electrochemical apparatus according to claim 11, wherein a melting point of the first adhesive layer is denoted as T1, and a melting point of the second adhesive layer is denoted as T2, wherein 95° C. ≤T1≤135° C. and 140° C. ≤T2≤190° C.

13. The electrochemical apparatus according to claim 11, wherein the pressure relief mechanism further comprises a first metal sheet, wherein the first metal sheet is disposed on a side of the adhesive film facing away from the housing; and the adhesive film further comprises a third adhesive layer, wherein the third adhesive layer is located between the second adhesive layer and the first metal sheet, and a melting point of the third adhesive layer is lower than the melting point of the second adhesive layer.

14. The electrochemical apparatus according to claim 13, wherein a melting point of the third adhesive layer is denoted as T3, and 95° C. ≤T3≤135° C.

15. The electrochemical apparatus according to claim 1, wherein the housing is provided with a groove, the first through hole extends through the groove, and the pressure relief mechanism is accommodated in the groove.

16. The electrochemical apparatus according to claim 1, wherein the first through hole is in a racetrack shape, rectangular shape, or elliptical shape.

17. The electrochemical apparatus according to claim 1, wherein the housing comprises a shell and a shell cover, wherein the shell comprises a bottom wall and a plurality of side walls surrounding the bottom wall, the bottom wall and the plurality of side walls together form an accommodation space with an opening, the shell cover seals the opening, the side wall is the first wall, and the bottom wall or the shell cover is the second wall.

18. The electrochemical apparatus according to claim 17, wherein the electrochemical apparatus further comprises a terminal post, wherein the terminal post and the first through hole are disposed on the same side wall or on different side walls.

19. The electrochemical apparatus according to claim 17, wherein the score groove is disposed in a corner region of the housing; and/or
the score groove in an arc shape and bends toward a center of the shell cover or the bottom wall where the score groove is located.

20. The electrochemical apparatus according to claim 19, wherein the electrochemical apparatus further comprises a terminal post, wherein the terminal post is disposed on the housing, and the score groove is disposed towards an end of the housing where the terminal post is located.

21. The electrochemical apparatus according to claim 1, wherein a width of the score groove gradually decreases in a direction toward the interior of the housing.

22. The electrochemical apparatus according to claim 1, wherein a maximum width of the score groove is denoted as W, and 0.02 mm≤W≤0.5 mm.

23. The electrochemical apparatus according to claim 21, wherein 0.05 mm≤W ≤0.2 mm.

24. The electrochemical apparatus according to claim 21, wherein 0.06 mm≤W ≤0.18 mm.

25. The electrochemical apparatus according to claim 1, wherein the thickness S2 of the second wall meets 0.03 mm≤S2≤0.3 mm.

26. An electric device, comprising the electrochemical apparatus according to claim 1, wherein the electrochemical apparatus is configured to provide electrical energy.
